(19) United States
(12) Patent Application Publication
(10) Pub. No.: US 2012/0159532 A1
(43) Pub. Date: Jun. 21, 2012

(54) CONTENT SHARING METHOD BASED ON NON-REALTIME IPTV SERVICE

(75) Inventors: Dae-Hee SEO, Daejon (KR); Hyeok Chan KWON, Daejon (KR); Seungmin LEE, Daejon (KR); Yong Hyuk MOON, Daejon (KR); Jae Hoon NAH, Daejon (KR); Taek Yong NAM, Daejon (KR); Dong Il SEO, Daejon (KR)

(73) Assignee: ELECTRONICS AND TELECOMMUNICATIONS RESEARCH INSTITUTE, Daejon (KR)

(21) Appl. No.: 13/167,256

(22) Filed: Jun. 23, 2011

(30) Foreign Application Priority Data
Dec. 17, 2010 (KR) 10-2010-0130302

(51) Int. Cl. H04N 7/167; H04N 7/16

(52) U.S. Cl. 725/30; 725/31

(57) ABSTRACT

A content sharing method performed in a content redistribution device based on a non-realtime IPTV service includes transmitting a secret key in password information of a user of the content redistribution device to an IPTV service server and storing a public key corresponding to the secret key; and transmitting an event message for content request to the IPTV service server to request a non-realtime IPTV service. Further, the content sharing method includes receiving contents requested in the event message for content requesting from the IPTV service server; and decoding the received contents and encrypting the decoded contents using the public key. Furthermore, the content sharing method includes transmitting the contents encrypted using the public key to content recipient devices; and generating an event message for content sharing using the public key to transmit the generated event message to the content recipient devices.

### CROSS-REFERENCE TO RELATED APPLICATION(S)

The present invention claims priority of Korean Patent Application No. 10-2010-0130302, filed on Dec. 17, 2010, which is incorporated herein by reference.

### FIELD OF THE INVENTION

The present invention relates to a method of content sharing based on a non-realtime IPTV service; and more particularly, to a method of safely sharing digital contents with a member in an identical or a different group existing on an identical or a different network using an advantage of one source multi-use with the use of SVC (Scalable Video Codec) in a non-realtime IPTV system.

### BACKGROUND OF THE INVENTION

As known in the art, much interest has been concentrated upon IPTV (Internet Protocol Television) because it can lead economic development as next-generation new growth dynamics. Most of IPTV services commercialized actively utilize user's privacy information. However, security services for utilization and management of the user's privacy information are necessarily required due to the publicity of the Internet. In addition, studies on the security for a non-realtime IPTV service are essentially required to support the variety of services for the reuse of contents for the purpose of one source multi-use.

A conventional content sharing method based on a non-realtime IPTV service includes a mobile content sharing method and a content sharing method based on P2P overlay network. The mobile content sharing method provides a safe content sharing method for preventing literary piracy and maintaining control of copyright holders for contents, and also provides new marketing possibilities to the copyright holders. However, the mobile content sharing method encrypts digital contents themselves, and hence it is inefficient to share mass digital contents. Further, in the mobile content sharing method, the authentication of respective license information is executed on a separate processor-based entity, and thus, only the authentication of a user terminal is performed. Therefore, an additional process for user authentication is required, and it is possible to ensure security of data for describing digital license information on a network.

The content sharing method based on the P2P overlay network employs overlay-based content search and transmission techniques having characteristics suitable for digital home community (DHC) environment. The content sharing method based on the P2P overlay network provides a safe communication method between different networks by sharing contents between home networks in the state that a home community is gradually formed, but authentication for devices is not performed in detail. The content sharing method based on the P2P overlay network is configured to support the connectivity of devices for supporting universal plug and play (UPnP) by enabling unauthorized users to access home network when searching and transmitting contents. Accordingly, the authentication of the users and devices is essentially required in view of construction of the home networks, but the content sharing method based on the P2P overlay network does not provide the authentication of the users and devices.

Accordingly, there needs a method for safely transmits contents provided from a non-realtime IPTV system to another authorized user for the purpose of the one source multi-use of the contents.

### SUMMARY OF THE INVENTION

In view of the above, the present invention provides a method of safely sharing contents capable of providing contents from an entity receiving the contents to another entity for the purpose of one source multi-use in a non-realtime IPTV system.

Further, the present invention provides a method of sharing contents capable of protecting users' privacies when implementing a non-realtime IPTV service and one source multi-use.

In accordance with a first aspect of the present invention, there is provided a content sharing method performed in a content redistribution device based on a non-realtime IPTV service, the method including transmitting a secret key in password information of a user of the content redistribution device to an IPTV service server and storing a public key corresponding to the secret key; transmitting an event message for content request to the IPTV service server to request a non-realtime IPTV service; receiving contents requested in the event message for content request from the IPTV service server, wherein the contents are subjected to hierarchical encryption; decoding the received contents and encrypting the decoded contents using the public key; transmitting the contents encrypted using the public key to content recipient devices existing on the same network as the content redistribution device or a different network from the content redistribution device and generating an event message for content sharing using the public key to transmit the generated event message to the content recipient devices.

In accordance with a second aspect of the present invention, there is provided a content sharing method performed in an IPTV service server based on a non-realtime IPTV service, the method including: receiving a secret key in password information from a user of a content redistribution device to store the received secret key as secret information of the user of the content redistribution device; verifying integrity of an event message for content request, provided from the content redistribution device; performing hierarchical encryption on contents requested in the event message for content request when the verification result is satisfied; transmitting the contents subjected to the hierarchical encryption to the content redistribution device; requesting the content redistribution device of a public key when receiving an event message for contents sharing, provided from a content recipient device; verifying integrity of the event message for content sharing using the public and secret keys received from the content redistribution device; and transmitting, to the content recipient device, contents applicable to device information of the content recipient device when the verification result is satisfied.

In accordance with a third aspect of the present invention, there is provided a content sharing method performed in a content recipient device based on a non-realtime IPTV service, the method including: receiving contents from a content redistribution device, wherein the contents have been encrypted using a public key of the content redistribution device; receiving an event message for content sharing from the content redistribution device, wherein the event message for content sharing is generated using the public key of the content redistribution device; extracting content characteristic information from the received event message for content sharing; performing compatibility examination for deciding whether or not contents are applicable to a device type of the content recipient device based on the extracted content information; transmitting the event message for content sharing together with user information of the content recipient device to an IPTV service server if it is decided that the compatibility is impossible, wherein the contents is usable in the content recipient device if it is decided that the compatibility is possible; and receiving contents requested in the event message for content sharing from the IPTV service server.

In accordance with the present invention, as set forth above, when non-realtime IPTV users exist in an identical or a different group existing on an identical or a different network, it is possible to provide convenience to the users and prevent illegal access of an unauthorized user without performing a separate authentication process or new device registration process. Thus, it is possible to provide a safe IPTV service when implementing a non-realtime IPTV in home network environment.

### BRIEF DESCRIPTION OF THE DRAWINGS

The objects and features of the present invention will become apparent from the following description of embodiments given in conjunction with the accompanying drawings, in which:

FIG. 1 is a block diagram of a non-realtime IPTV service system in accordance with an embodiment of the present invention; and

FIGS. 2A and 2B are a flowchart illustrating a content sharing method based on a non-realtime IPTV service in accordance with an embodiment of the present invention.

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, embodiments of the present invention will be described in detail with reference to the accompanying drawings which form a part hereof.

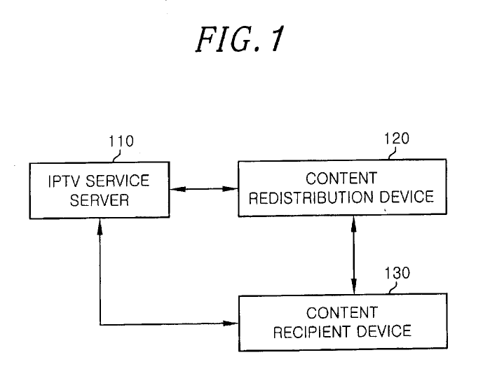

FIG. 1 is a block diagram of a non-realtime IPTV service system in accordance with an embodiment of the present invention.

As shown in FIG. 1, the non-realtime IPTV service system includes an IPTV service server 110 and a plurality of user terminals 120 and 130 connected to the IPTV service server 110. The IPTV service server 110 provides an IPTV service, e.g., IPTV contents, to a plurality of user terminals in non-real time. The plurality of user terminals 120 and 130 access the IPTV service server 110 to request for the IPTV service. Then, the plurality of user terminals 120 and 130 download the requested IPTV service from the IPTV service server 110. One of the user terminals, e.g., the user terminal 120 distributes IPTV contents downloaded from the IPTV service server 110 in order for sharing the contents with another user terminals. Hereinafter, the terminal that distributes the IPTV contents for sharing with another user terminals is referred to as a content redistribution device 120, and respective terminal that receives the redistributed contents from the content redistribution device 120 is collectively referred to as a content recipient device 130.

The IPTV service server 110 receives a secret key in password information from a user of the content redistribution device 120 and stores the received secret key as secret information of the user. When an event message for content request is received from the content redistribution device 120, the IPTV service server 110 verifies integrity of the event message for content request. If the verification result is satisfied, the IPTV service server 110 performs hierarchical encryption on contents requested in the event message for content request and transmits the hierarchically encrypted contents to the content redistribution device 120. When an event message for content sharing is received from the content recipient device 130, the IPTV service server 110 requests the content redistribution device 120 of a public key, and verifies integrity of the event message for content sharing using the public and secret keys received from the content redistribution device 120. If the verification result is satisfied, the IPTV service server 110 transmits contents suitable to device information of the content recipient device 130 to the content recipient device 130.

The content redistribution device 120 transmits a secret key in the password information of the user thereof to the IPTV service server 110 and stores a public key corresponding to the secret key therein. The content redistribution device 120 transmits an event message for content request to the IPTV service server 110, and receives contents requested in the event message for content request from the IPTV service server 110. The content redistribution device 120 decodes the received contents and then encrypts the decoded contents using the public key. Then, the content redistribution device 120 transmits the contents encrypted using the public key to the content recipient device 130 existing on the same network as the content redistribution device 120 or a different network from the content redistribution device 120. Further, the content redistribution device 120 generates the event message for content sharing using the public key and then transmits the event message for content sharing to the content recipient device 130.

The content recipient device 130 receives contents performed through the content redistribution device 120 on the identical or different network, and receives an event message for content sharing from the content redistribution device 120. The content recipient device 130 extracts content characteristic information from the received event message for content sharing, and performs compatibility examination for deciding whether or not the contents is applicable to its own device type based on the extracted content information. If it is decided that the compatibility is possible, the content recipient device 130 is capable of using the contents. However, if it is decided that the compatibility is impossible, the content recipient device 130 transmits the event message for content sharing together with user information to the IPTV service server 110, and receives contents requested in the event message for content sharing from the IPTV service server 110.

A content sharing method of the non-realtime IPTV system configured as set forth above will be described hereinafter.

First of all, symbols to be used below will be defined so as to describe a content sharing method based on a non-realtime IPTV service in accordance with an embodiment of the present invention.

P: User password information, in which K(n)=1 and 1≦n≦N when K(P₁, . . . , P_{N}), and all the password information is configured as hash function ζᵣ(s₁, . . . , s_{N}; P₁, . . . , Pₙ);

u1: Entity that receives contents in non-realtime through communication with a non-realtime IPTV, which is a user of a content redistribution device;

u2: Entity that exists on the same network as U1, which is a user of a content recipient device belonging to an identical or a different group;

ID: ID of a user using a non-realtime IPTV service;

T: Time stamp;

h( ): Safe hash function;

Dᵢ: information of the content redistribution device or content recipient device; and

C_{type}: Characteristic information of contents.

Before describing the content sharing method, assumption details for safe redistribution of content will be made as follows.

First, the user u1 transmits sₖεs₁, . . . , s_{N} to the IPTV service server through a safe communication path through a safe initial process.

Second, password information P between members in an identical or a different group that exists on an identical or a different network is mutually exchanged through the safe communication path.

Third, all the users safely register their device information in advance.

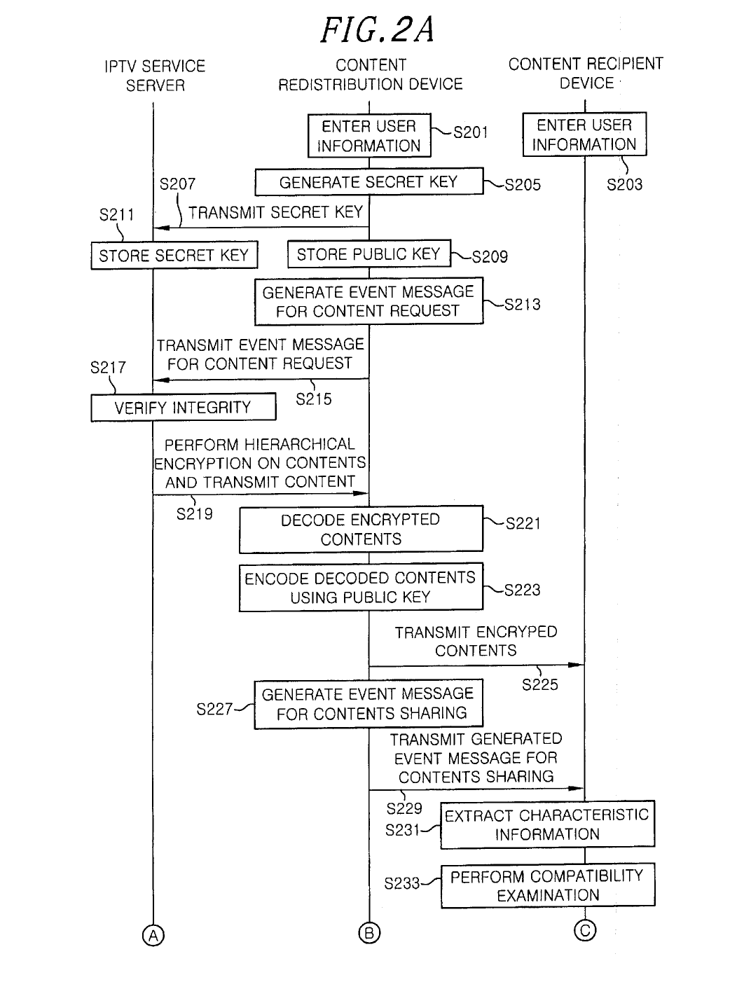

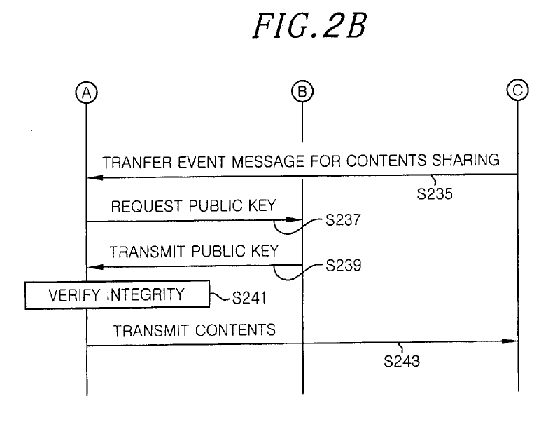

A process of safely redistributing contents in the IPTV service system in accordance with the embodiment of the present invention will be described with reference to FIGS. 2A and 2B.

First, in step S201, a user u1 enters user information including a password to the content redistribution device 120, and, in step S203, a user u2 also enters user information including a password to the content recipient device 130.

The content redistribution device 120 generates a secret key Sₖ from the user information in step S205 and transmits the secret key sₖ to the IPTV service server 110 in step S207. In addition, a public key Pₖ corresponding to the secret key sₖ is safely stored in the content redistribution device 120 in step S209.

Thereafter, the IPTV service server 110 stores the secret key sₖ received from the content redistribution device 120 as user's secret information in step S211.

In a case where the user of the content redistribution device 120 is an initially registered user, an event message for content request ‘e’ is generated using the following Expression 1 in step S213.

e=<IDᵤ₁,h(sₖ),Dᵢ,C_{type},Tᵤ₁>

The event message for content request includes a user ID of the content redistribution device, hash function of the secret key, information on the content redistribution device, characteristic information of the contents, and time stamp of the user of the content redistribution device.

Subsequently, the content redistribution device 120 transmits the event message for content request ‘e’ to the IPTV service server 110 in step S215.

In step S217, the IPTV service server 110 verifies integrity of the user ID and secret key sₖ in the event message for content request, received from the content redistribution device 120. If the integrity verification result is satisfied, in step S219, the IPTV service server 110 performs hierarchical encryption on contents requested in the event message for content request and transmits the contents subjected to the hierarchical encryption to the content redistribution device 120.

The integrity verification process performed by the IPTV service server 110 is performed as follows.

In a case where K(P₁, . . . , P_{N}), 1≦n≦N when K(n)=1, and a nominal of all the user password information P_{N} is represented by the following Expression 2.

$${ζ}_{r} ( {s}_{1} , … , {s}_{N} ; {P}_{1} , … , {P}_{N} ) = {\sum }_{{m}_{1} = 1}^{∞} … {\sum }_{{m}_{r} = 1}^{∞} … {\prod }_{n = 1}^{N} {( {a}_{1} ( n ) {m}_{1}^{{p}_{1} ( 1 , n )} … {m}_{r}^{{p}_{r} ( 1 , n )} )}^{- {s}_{n}} = {{a}_{1} ( 1 )}^{- {s}_{1}} … {{a}_{1} ( N )}^{- {s}_{N}} {\sum }_{j = 1}^{r} ζ ( {p}_{j} ( 1 , 1 ) {s}_{1} + … + {p}_{j} ( 1 , N ) {s}_{N} \qquad [ Expression 2 ]$$

If the Expression 2 is not satisfied, the integrity verification at step 217 is failed. In this case, the IPTV service server 110 may need the content redistribution device 120 to retransmit the event message for content request.

Meanwhile, the content redistribution device 120 decodes the encrypted contents received from the IPTV service server 110 in step S221, and then encrypts the decoded contents using the public key Pₖ in step S223. Thereafter, the content redistribution device 120 transmits the encrypted contents using the public key Pₖ to the content recipient device 130 existing on the same network as the content redistribution device 120 or a different network from the content redistribution device 120 in step S225.

In order to share the contents with the content recipient device 130 in a group existing on the same network as the content redistribution device 120 or a different network from the content redistribution device 120, the content redistribution device 120 extracts a public key Pₖ when K(n)=1, where 1≦n≦1, and generates an event message for content sharing ‘e2’, represented by the following Expression 3, using the extracted public key Pₖ in step S227.

ζᵣ(sₖ;Pₖ),e₂=<IDᵤ₁,h(ζₖ),Dᵢ,C_{type},Tᵤ₁>

The event message for content sharing includes a user ID of the content redistribution device, has function of the password information, device information of the content redistribution device, characteristic information of the contents, and user time stamp of the content redistribution device.

Next, the content redistribution device 120 transmits the generated event message for content sharing to the content recipient device 130 in step S229.

The content recipient device 130 then extracts characteristic information C_{type} of the contents from the event message for content sharing, received from the content redistribution device 120 in step S231. After that, the content recipient device 130 performs compatibility examination for deciding whether or not the extracted characteristic information C_{type} is applicable to device type of the content recipient device 130 in step S233. If it is decided that the compatibility is possible, the content recipient device 130 is capable of using the contents. If, however, it is decided that the compatibility is impossible, the content recipient device 130 transmits the event message for content sharing together with the user information IDᵤ₂ of the content recipient device 130 to the IPTV service server 110 in step S235.

Subsequently, the IPTV service server 110 generates a safe hash function h(IDᵤ₂∥ID_{IPTV}) and a password secret key ζ(Sₖ) based on information transmitted from the content recipient device 130 and transmits them to the content retribution device 120 to request the user password information ζ of the content retribution device 120 in step S237. In response to the request of the user password information, the content redistribution device 120 transmits the public key Pₖ to the IPTV service server 110 in step S239.

The IPTV service server 110 calculates password information ζ( ) using the public and secret keys Pₖ and sₖ received from the content redistribution device 120, and verifies integrity of the safe hash function h(ζₖ) in step S241. If the integrity verification result is satisfied, the IPTV service server 110 provides, to the content recipient device 130, contents suitable to the device information of the content recipient device 130 in step S243.

While the invention has been shown and described with respect to the preferred embodiments, it will be understood by those skilled in the art that various changes and modifications may be made without departing from the scope of the invention as defined in the following claims.

What is claimed is:

1. A content sharing method performed in a content redistribution device based on a non-realtime IPTV service, the method comprising:
transmitting a secret key in password information of a user of the content redistribution device to an IPTV service server and storing a public key corresponding to the secret key;
transmitting an event message for content request to the IPTV service server to request a non-realtime IPTV service;
receiving contents requested in the event message for content request from the IPTV service server, wherein the contents are subjected to hierarchical encryption;
decoding the received contents and encrypting the decoded contents using the public key;
transmitting the contents encrypted using the public key to content recipient devices existing on the same network as the content redistribution device or a different network from the content redistribution device; and
generating an event message for content sharing using the public key to transmit the generated event message to the content recipient devices.

2. The method of claim 1, wherein the event message for content request includes a user ID of the content redistribution device, hash function of the secret key, information on the content redistribution device, characteristic information of the contents and user's time stamp of the content redistribution device.

3. The method of claim 1, wherein the event message for content sharing includes a user ID of the content redistribution device, has function of the password information, device information of the content redistribution device, characteristic information of the contents, and user's time stamp of the content redistribution device.

4. A content sharing method performed in an IPTV service server based on a non-realtime IPTV service, the method comprising:
receiving a secret key in password information from a user of a content redistribution device to store the received secret key as secret information of the user of the content redistribution device;
verifying integrity of an event message for content request, provided from the content redistribution device;
performing hierarchical encryption on contents requested in the event message for content request when the verification result is satisfied;
transmitting the contents subjected to the hierarchical encryption to the content redistribution device;
requesting the content redistribution device of a public key when receiving a event message for contents sharing, provided from a content recipient device;
verifying integrity of the event message for content sharing using the public and secret keys received from the content redistribution device; and
transmitting, to the content recipient device, contents applicable to device information of the content recipient device when the verification result is satisfied.

5. The method of claim 4, wherein the event message for content request includes a user ID of the content redistribution device, hash function of the secret key, information on the content redistribution device, characteristic information of the contents and user's time stamp of the content redistribution device.

6. The method of claim 4, wherein the event message for content sharing includes a user ID of the content redistribution device, has function of the password information, device information of the content redistribution device, characteristic information of the contents, and user's time stamp of the content redistribution device.

7. A content sharing method performed in a content recipient device based on a non-realtime IPTV service, the method comprising:
receiving contents from a content redistribution device, wherein the contents have been encrypted using a public key of the content redistribution device;
receiving an event message for content sharing from the content redistribution device, wherein the event message for content sharing is generated using the public key of the content redistribution device;
extracting content characteristic information from the received event message for content sharing;
performing compatibility examination for deciding whether or not contents are applicable to a device type of the content recipient device based on the extracted content information;
transmitting the event message for content sharing together with user information of the content recipient device to an IPTV service server if it is decided that the compatibility is impossible, wherein the contents is usable in the content recipient device if it is decided that the compatibility is possible; and
receiving contents requested in the event message for content sharing from the IPTV service server.

8. The method of claim 7, wherein the event message for content sharing includes a user ID of the content redistribution device, has function of the password information, device information of the content redistribution device, characteristic information of the contents, and user's time stamp of the content redistribution device.
